(19) United States
(12) Patent Application Publication
(10) Pub. No.: US 2024/0291407 A1
(43) Pub. Date: Aug. 29, 2024

(54) DRIVER DEVICE, WATER TREATMENT APPARATUS, AND MOTOR DRIVING DEVICE

(71) Applicant: Rohm Co., Ltd., Kyoto (JP)

(72) Inventors: Hiroki HASHIMOTO, Kyoto (JP); Mitsuo OKADA, Kyoto (JP)

(21) Appl. No.: 18/654,938

(22) Filed: May 3, 2024

Related U.S. Application Data
(63) Continuation of application No. PCT/JP2022/036739, filed on Sep. 30, 2022.

(30) Foreign Application Priority Data
Nov. 5, 2021 (JP) 2021-180973

(51) Int. Cl. H02P 8/32; C02F 1/461

(52) U.S. Cl. CPC H02P 8/32; C02F 1/4618; C02F 2001/46185; C02F 2201/4614; C02F 2201/46175

(57) ABSTRACT

A driver device (1) includes a pulse generation circuit (5) that generates, within one period, a pulse waveform (Spl) with a first voltage level in a first period (T1) and a pulse waveform with a second voltage level in a second period (T2). A control circuit (2) makes the first period equal to a minimum on period (Tminon) to perform a supply mode for the minimum on period and, if at the end of the minimum on period the output current (Iout) has reached the set current value (Iset), the control circuit makes a switch to a decay mode and performs a skip of a switch to the supply mode at the end of the second period.

### CROSS-REFERENCE TO RELATED APPLICATIONS

This nonprovisional application is a continuation application of International Patent Application No. PCT/JP2022/036739 filed on Sep. 30, 2022, which claims priority Japanese Patent Application No. 2021-180973 filed on Nov. 5, 2021, the entire contents of which are hereby incorporated by reference.

### TECHNICAL FIELD

The present disclosure relates to driver devices, water treatment apparatuses, and motor driving devices.

### BACKGROUND ART

Stepping motors are used in a variety of applications as in copiers, sheet feeders in printers, and document readers in scanners. A type of driver device (motor driver) for a stepping motor includes, for each of motor coils of different phases, a full-bridge circuit (H-bridge circuit) that supplies it with an output current (coil current). Changing stepwise the polarity or magnitude of the output currents to the motor coils of different phases permits a rotor to rotate stepwise.

Driver devices for stepping motors typically employ PWM constant-current control to control output currents. Through PWM constant-current control, during a desired period while a rotor is rotating, the value of the output current supplied to the motor coil of each phase is kept around a target current value.

### CITATION LIST

### Patent Literature

Patent Document 1: JP-A-2017-156246

### BRIEF DESCRIPTION OF DRAWINGS

FIG. 1 is a diagram showing the configuration of a hypochlorous acid water generating apparatus according to an illustrative embodiment.

FIG. 2 is a diagram showing a specific configuration example of a CR timer.

FIG. 3 is a timing chart showing an example of waveforms observed in PWM constant-current control.

FIG. 4A is a diagram showing states of an H-bridge circuit in a supply mode and in a slow decay mode.

FIG. 4B is a diagram showing states of an H-bridge circuit in a supply mode and in a fast decay mode.

FIG. 5 is a flow chart of output current control according to a first scheme.

FIG. 6 is a diagram showing an example of waveforms observed in the output current control according to the first scheme.

FIG. 7 is a flow chart of output current control according to a second scheme.

FIG. 8 is a diagram showing an example of waveforms observed in the output current control according to the second scheme.

FIG. 9 is a flow chart of output current control according to a third scheme.

FIG. 10 is a flow chart of output current control according to a fourth scheme.

FIG. 11 is a flow chart of output current control according to a fifth scheme.

FIG. 12 is a diagram showing an example of waveforms observed in the output current control according to the fifth scheme.

FIG. 13 is a diagram showing a configuration example for sensing an output current in a decay mode.

FIG. 14 is a diagram showing the configuration of a motor driving device according to an illustrative embodiment.

### DESCRIPTION OF EMBODIMENTS

An illustrative embodiment will be described below with reference to the accompanying drawings.

### 1. Hypochlorous Acid Water Generating Apparatus

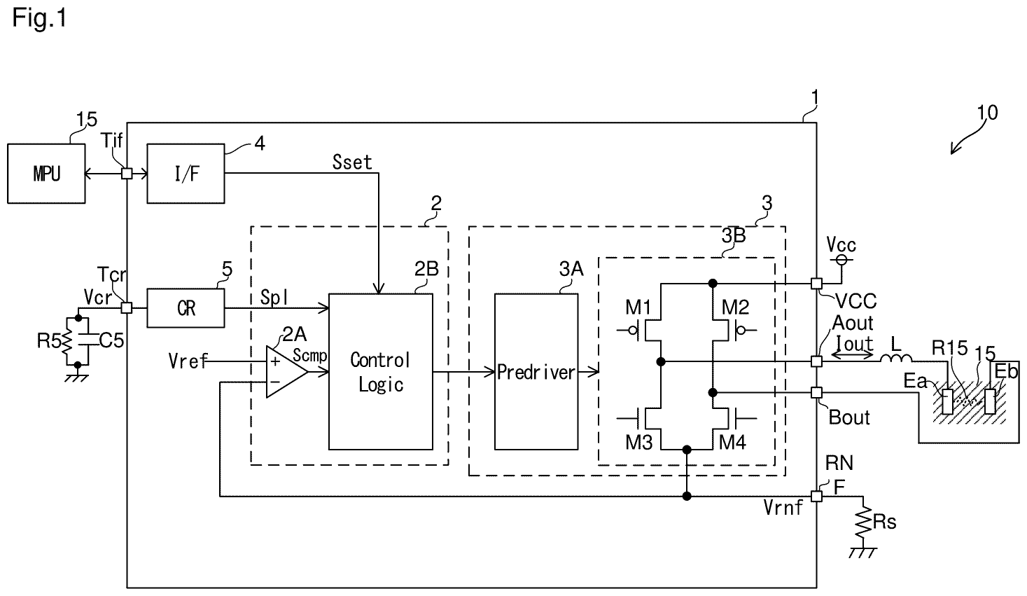

FIG. 1 is a diagram showing the configuration of a hypochlorous acid water generating apparatus 10 according to an illustrative embodiment. The hypochlorous acid water generating apparatus 10 includes a driver device 1 as one example according to the present disclosure. That is, the driver device 1 is used in an application intended to generate hypochlorous acid water. The hypochlorous acid water generating apparatus 10 generates hypochlorous acid water by electrolyzing water 15 (e.g., a water solution of sodium chloride) as will be described later. The generated hypochlorous acid water is used for disinfection in a variety of applications.

As shown in FIG. 1, the hypochlorous acid water generating apparatus 10 includes a driver device 1, a coil L, electrodes Ea and Eb, and an MPU (microprocessor unit) 15. The hypochlorous acid water generating apparatus 10 also includes, as components externally connected to the driver device 1, a setting resistor R5, a setting capacitor C5, and a current sense resistor Rs.

The driver device 1 includes, as its internal blocks, a control circuit 2, an output stage circuit 3, a serial interface 4, and a CR timer 5. The driver device 1 can be configured as a semiconductor device that includes an IC having those internal blocks integrated in it. The driver device 1 also has, as external terminals for electrical connection with the outside, an interface terminal Tif, a CR setting terminal Tcr, a supply terminal VCC, output terminals Aout and Bout, and a resistor connection terminal RNF.

The supply terminal VCC is fed with a supply voltage Vcc from outside. The supply voltage Vcc is a positive direct-current voltage. The circuits inside the driver device 1 operate from the supply voltage Vcc.

The coil L is provided outside the driver device 1. The output terminal Aout is connected to one terminal of the coil L. The other terminal of the coil L is connected to the electrode Ea. The electrode Eb is connected to the output terminal Bout. The coil L may be provided between the electrode Eb and the output terminal Bout. The electrodes Ea and Eb are immersed in, for example, water 15 in a container.

An output current Iout passes between the output terminals Aout and Bout. The output current Iout passes via a water quality resistance R15 (i.e., the resistance of the water 15) present between the electrodes Ea and Eb. The output current Iout is assumed to have a positive polarity when it passes from the output terminal Aout to the output terminal Bout via the coil L, and is assumed to have a negative polarity when it passes in the opposite direction. Passing the output current Iout through the water 15 causes the water 15 to be electrolyzed, and this produces hypochlorous acid water.

The current sense resistor Rs is provided outside the driver device 1; it is connected between the resistor connection terminal RNF and an application terminal for a ground potential. The current sense resistor Rs senses the output current Iout by generating a current sense signal Vrnf through current-voltage conversion on the output current Iout. The current sense signal Vrnf is a voltage that is applied to the resistor connection terminal RNF.

The control circuit 2 is fed with a reference voltage Vref, the current sense signal Vrnf, a setting signal Sset, and a pulse signal Spl.

The serial interface 4 serially communicates with the MPU 15 via the interface terminal Tif. Note that in FIG. 1, for convenience' sake, the interface terminal Tif is illustrated in a simplified form: in practice it is configured according to the actually employed serial communication standard (such as SPI or I2C). By serial communication the setting signal Sset is fed from the serial interface 4 to the control circuit 2. The setting signal Sset is used to make various settings in the control circuit 2 (a control logic 2B, which will be described later). The various settings include, among others, the polarity of the output current Iout and the number of skips to be made to skip a switch from a decay mode to a supply mode, which will be described later.

The pulse signal Spl is generated by the CR timer 5 (pulse generation circuit). The CR timer 5 generates the pulse signal Spl while generating a CR voltage Vcr, which is a triangular-wave signal, by controlling the charging and discharging of the setting capacitor C5 connected to the CR setting terminal Tcr.

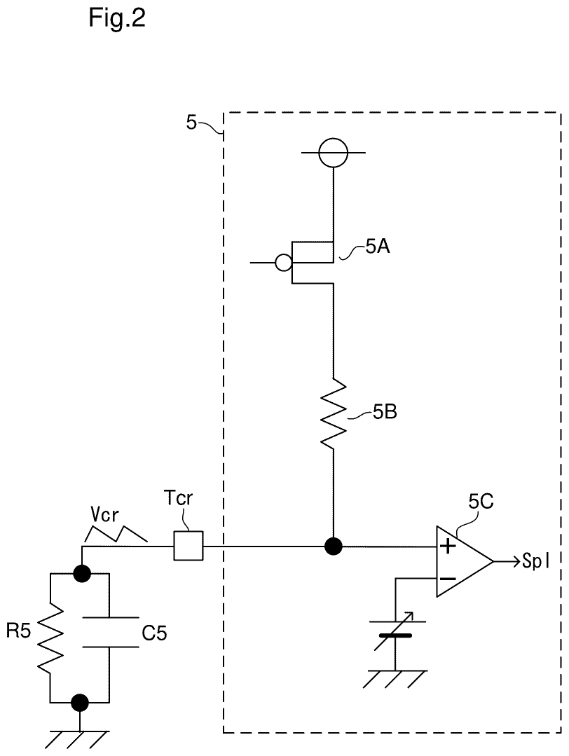

FIG. 2 is a diagram showing a specific configuration example of the CR timer 5. The CR timer 5 includes a switch 5A, a resistor 5B, and a comparator 5C.

The switch 5A is configured with a PMOS transistor. The source of the switch 5A is connected to an application terminal for the supply voltage. The drain of the switch 5A is connected to one terminal of the resistor 5B. The other terminal of the resistor 5B is connected to the CR setting terminal Tcr and to the non-inverting input terminal (+) of the comparator 5C. The inverting input terminal (−) of the comparator 5C is fed with a datum voltage. The comparator 5C has hysteresis. The comparator 5C outputs the pulse signal Spl.

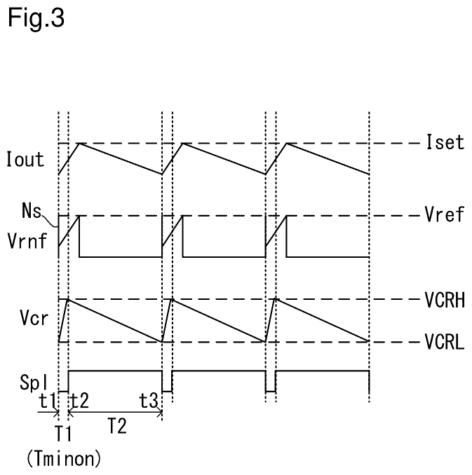

The operation of the CR timer 5 configured as described above will now be described with reference also to FIG. 3. FIG. 3 is a timing chart showing an example of the waveforms of the output current Iout, the current sense signal Vrnf, the CR voltage Vcr, and the pulse signal Spl. A method for the PWM constant-current control on the output current Iout shown in FIG. 3 will be described in detail later.

When the switch 5A is switched from off to on, the setting capacitor C5 starts to be charged with the supply voltage via the switch 5A, the resistor 5B, and the CR setting terminal Tcr. Thus the CR voltage Vcr appearing at the CR setting terminal Tcr starts to rise (timing t1 in FIG. 3). When the CR voltage Vcr becomes higher than a predetermined upper CR voltage threshold value VCRH (timing t2), the pulse signal Spl rises from low level to high level and the switch 5A is switched from on to off. As a result, the setting capacitor C5 starts to be discharged by the setting resistor R5 and the CR voltage Vcr starts to fall. When the CR voltage Vcr becomes lower than a predetermined lower CR voltage threshold value VCRL (timing t3), the pulse signal Spl falls from high level to low level and the switch 5A is switched from off to on. As a result, the setting capacitor C5 starts to be charged and the CR voltage Vcr starts to rise. Through repetition of this sequence, the CR voltage Vcr, which is a triangular-wave signal, is generated and, as the output of the comparator 5C, the pulse signal Spl, which comprises a low level (a first voltage level) and a high level (a second voltage level), is generated.

With reference back to FIG. 1, based on the reference voltage Vref, the current sense signal Vrnf, the setting signal Set, and the pulse signal Spl, the control circuit 2 controls the output stage circuit 3 so that the output current Iout has a magnitude corresponding to the reference voltage Vref and that the output current Iout has a polarity corresponding to the setting signal Sset.

Specifically, the control circuit 2 includes a comparator 2A and a control logic 2B. The non-inverting input terminal (+) of the comparator 2A is fed with the reference voltage Vref, and the inverting input terminal (−) of the comparator 2A is fed with the current sense signal Vrnf. The comparator 2A compares Vref with Vrnf and feeds a comparison result signal Scmp indicating the result of the comparison to the control logic 2B. The comparison result signal Scmp is at high level if the reference voltage Vref is higher than the current sense signal Vrnf, and is at low level if the reference voltage Vref is lower than the current sense signal Vrnf.

The output stage circuit 3 includes a pre-driver 3A and an H-bridge circuit (full-bridge circuit) 3B. Based on the comparison result signal Scmp, the pulse signal Scpl, and the setting signal Sset, the control logic 2B generates a motor driving signal that specifies the on/off states of output transistors in the H-bridge circuit 3B, and feeds the generated motor driving signal to the pre-driver 3A. According to the motor driving signal the pre-driver 3A turns on and off individually the plurality of output transistors in the H-bridge circuit 3B. Here, the control logic 2B generates the motor driving signal, based on the comparison result signal Scmp in the period in which the output current Iout passes from the resistor connection terminal RNF via the current sense resistor Rs to the ground, such that in that period the current sense signal Vrnf reaches the reference voltage Vref and that the output current Iout has the polarity specified by the setting signal Sset.

In this way, the reference voltage Vref and the setting signal Sset constitute a current setting signal (in other words, a current specifying signal) that sets a target setting value of the output current Iout to be supplied to the coil L. Since the current sense signal Vrnf is controlled to reach the reference voltage Vref, the output current Iout has a magnitude proportional to the reference voltage Vref. That is, the reference voltage Vref sets the target magnitude of the output current Iout. Moreover, the setting signal Sset sets the target polarity of the output current Iout.

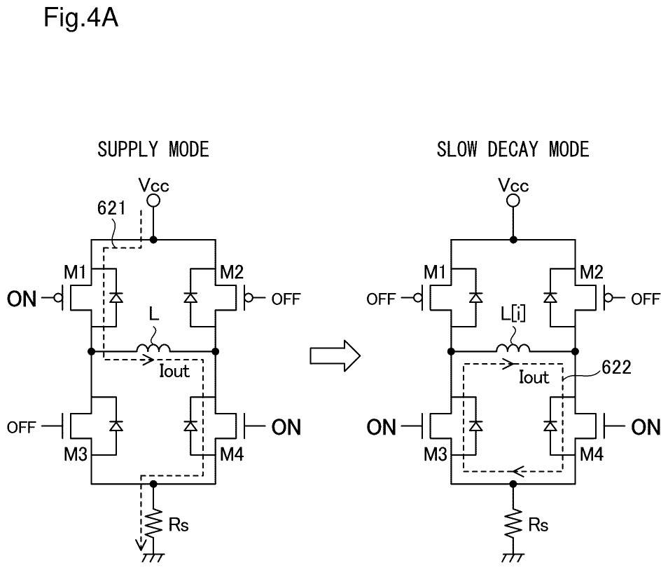

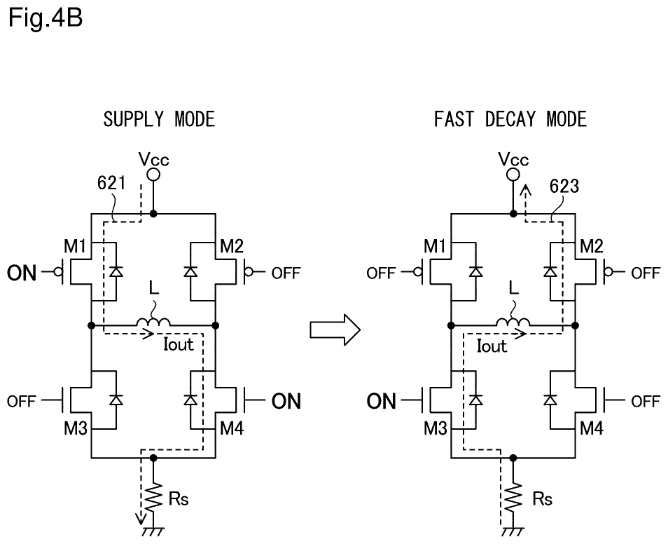

The H-bridge circuit 3B includes output transistors (upper transistors) M1 and M2 configured as P-channel MOSFETs and output transistors (lower transistors) M3 and M4 configured as N-channel MOSFETs. A P-channel MOSFET is accompanied by a parasitic diode of which the forward direction points from the drain to the source, and an N-channel MOSFET is accompanied by a parasitic diode of which the forward direction points from the source to the drain, though these parasitic diodes are omitted from illustration in FIG. 1 (they are shown in FIGS. 4A and 4B, which will be referred to later).

In the H-bridge circuit 3B, the sources of the output transistors M1 and M2 are both connected to the supply terminal VCC, so that the sources of the output transistors M1 and M2 are fed with the supply voltage Vcc. In the H-bridge circuit 3B, the drains of the output transistors M1 and M3 are both connected to the output terminal Aout, the drains of the output transistors M2 and M4 are both connected to the output terminal Bout, and the sources of the output transistors M3 and M4 are both connected to the resistor connection terminal RNF. The pre-driver 3A, by controlling the gates of the output transistors M1 to M4 according to the motor driving signal from the control logic 2B, turns the output transistors M1 to M4 on and off individually.

While here an example is dealt with where the H-bridge circuit 3B is configured with P- and N-channel MOSFETs, the output transistors in the H-bridge circuit 3B may all be N-channel MOSFETs. In that case, the circuit is modified accordingly. Instead of MOSFETs, bipolar transistors may be used to constitute the H-bridge circuit 3B.

### 2. PWM Constant-Current Control

Next, the PWM constant-current control performed in the driver device 1 will be described with reference to FIG. 3 as well as FIGS. 4A and 4B. The following description assumes, as one example, that the output current Iout has a positive polarity.

As shown in FIG. 3, at the start timing t1 of a first period T1 in which the pulse signal Spl is at low level (first voltage level) (i.e. at a falling edge), the motor driving signal from the control logic 2B keeps, as shown at left in FIG. 4A, the output transistors M1 and M4 on and the output transistors M2 and M3 off. Thus, as indicated by a broken-line arrow at left in FIG. 4A, a positive output current Iout starts to pass across a current path from the application terminal for the supply voltage Vcc via M1, the coil L, M4, and the current sense resistor Rs and the output current Iout starts increasing. Accordingly, the start timing t1 of the first period T1 is the start timing of a supply mode.

Here, at the start of the supply mode, the current sense signal Vrnf exhibits spike noise Ns (FIG. 3). To invalidate detection of the spike noise Ns by the comparator 2A, the first period T1 is made equal to a minimum on period Tminon and during this period Tminon, regardless of the comparison result from the comparator 2A, the control logic 2B continues with the supply mode. Thus the output current Iout continue increasing.

Then, at the timing of a switch of the pulse signal Spl from low level to high level (at a rising edge), that is, after the timing t2 of a transition from the first period T1 to a second period T2, when the current sense signal Vrnf reaches the reference voltage Vref, based on the comparison result from the comparator 2A, the control logic 2B makes a switch from the supply mode to the decay mode. Now, for example as shown at right in FIG. 4A, the output transistors M1 and M2 are kept off and the output transistors M3 and M4 are kept on.

Shown at right in FIG. 4A is, as one type of decay mode, a slow decay mode. As indicated by a broken-line arrow at right in FIG. 4A, in the slow decay mode, a positive output current Iout passes across a path that circulates via M3, the coil L, and M4. The magnitude of the output current Iout diminishes as time passes. In the slow decay mode, no current passes in the current sense resistor Rs and thus the current sense signal Vrnf equals 0 V (FIG. 3).

Then, at the timing at which the pulse signal Spl switches from high level to low level (at a falling edge), that is, at the end timing t3 of the second period T2, the control logic 2B makes a switch from the decay mode to the supply mode. Accordingly, the state at left in FIG. 4A is resumed and the positive output current Iout start rising.

Through repetition of this sequence, by PWM constant-current control the output current Iout is kept around a set current value Iset corresponding to the reference voltage Vref.

The decay mode may be implemented as, instead of a slow decay mode as described above, a fast decay mode as described below. Shown at right in FIG. 4B is a state of the H-bridge circuit 3B in the fast decay mode. In the fast decay mode, the output transistors M1, M2, and M4 are kept off and the output transistor M3 is kept on. Thus, as indicated by a broken-line arrow at right in FIG. 4B, the output current Iout passes across a path via an application terminal for the ground, the current sense resistor Rs, the output transistor M3, the coil L, and the parasitic diode in M2 to the application terminal for the supply voltage Vcc, and the magnitude of the output current Iout diminishes with time. In this case, the reference voltage Vref is a negative voltage.

Slow decay mode versus fast decay mode: the decay rate of the output current Iout in the slow decay mode is lower than the decay rate of the output current Iout in fast slow decay mode. As is well known, the slow decay mode and the fast decay mode each have its advantages and disadvantages.

In a case where the output current Iout has a negative polarity, in the supply mode the output transistors M1 and M4 can be kept off and the output transistors M2 and M3 can be kept on. In this case, in the fast decay mode the output transistors M1, M2, and M3 can be kept off and the output transistor M4 can be kept on.

### 3. Current Overshoot

In PWM constant-current control as described above, if, depending on the impedance value of the coil L or the value of the water quality resistance R15, in the supply mode the output current Iout increases too fast or in the decay mode the output current Iout decreases too little, a phenomenon may be observed in which the output current Iout increases so far that its magnitude exceeds that of the set current value Iset (phenomenon called a current overshoot). Making the coil L smaller reduces its inductance value, causing the output current Iout to increase faster.

To prevent the current overshoot mentioned above, the embodiment employs output current control as described below.

### 4. Output Current Control

### <4-1. First Scheme>

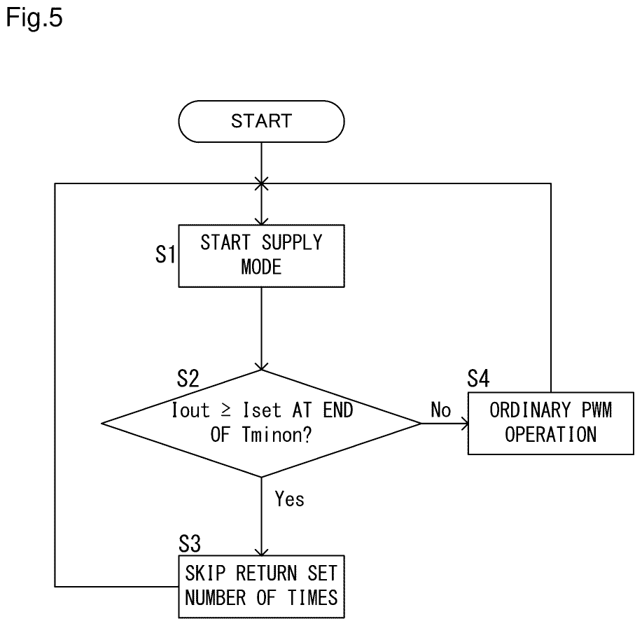

FIG. 5 is a flow chart of output current control according to a first scheme. Note that the control logic 2B is the entity that performs the control shown in the flow charts, including FIG. 5, of different schemes described below.

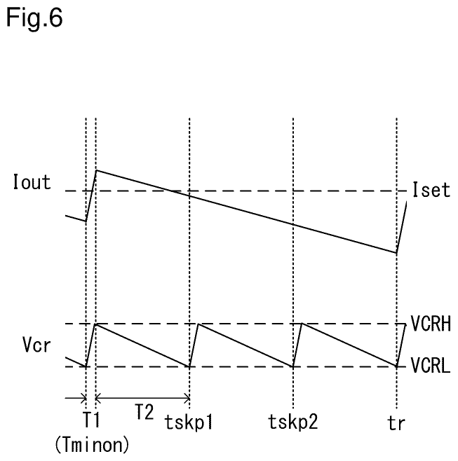

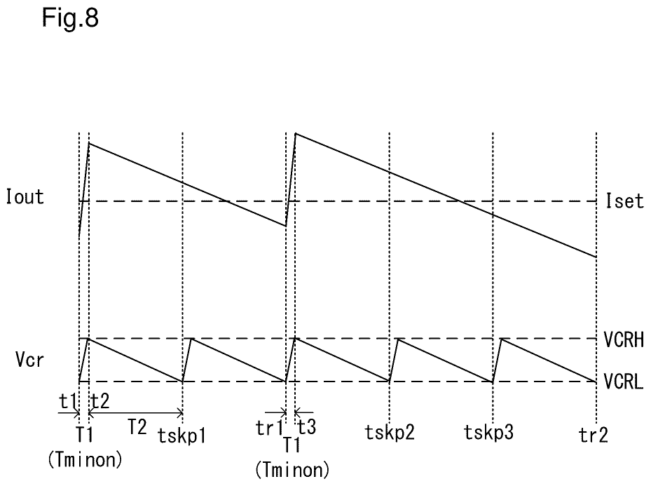

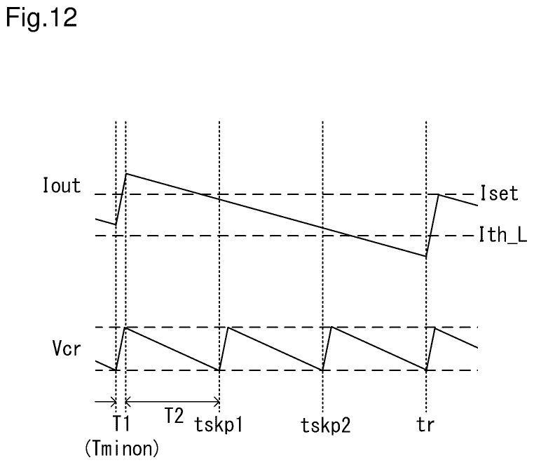

The control in FIG. 5 proceeds as follows. First, at Step S1, the supply mode is started. FIG. 6 is a diagram showing an example of waveforms observed in the output current control according to the first scheme. FIG. 6 shows the waveforms of, from top down, the output current Iout and the CR voltage Vcr (the same applies to FIGS. 8 and 12, which will be referred to later). At the start of a first period T1 in FIG. 6, the supply mode is started and the output current Iout starts increasing.

When at the end of the first period T1, that is, the minimum on period Tminon, at Step S2, the control logic 2B checks whether the output current Iout has reached the set current value Iset. The check here is made based on the result of comparison of the current sense signal Vrnf with the reference voltage Vref by the comparator 2A.

If the output current Iout has reached the set current value Iset (Step S2, Yes), an advance is made to Step S3. At Step S3, first, a switch is made from the supply mode to the decay mode. Thus, the output current Iout starts decreasing. At the end of the second period T2, at which in ordinary PWM constant-current control a switch to the supply mode would be made, no switch to the supply mode is made. That is, a switch to the supply mode is skipped. Then the decay mode is continued throughout the first and second periods T1 and T2. In the following description, this operation of skipping a switch to the supply mode and continuing with the decay mode will be called skipping operation. At Step S3, skipping operation is performed a set number of times as previously set.

FIG. 6 shows an example where the set number of times to perform skipping operation is two. That is, a switch to the supply mode is skipped at timings tskp1 and tskp2 at which the second period T2 ends. After Step S3, a return is made to Step S1, where the supply mode is started. In the example in FIG. 6, at the end of the second period T2 after timing tskp2, that is, at timing tr, a switch to the supply mode is made. Thus, the decay mode is continued from the end timing of the minimum on period Tminon to timing tr and thus the output current Iout decreases; at timing tr, the output current Iout starts increasing.

If at the end of the minimum on period Tminon, at Step S2, the output current Iout has not reached the set current value Iset (Step S2, No), an advance is made to Step S4, where ordinary PWM constant-current control is performed.

Skipping operation as described above permits the decay mode to last longer and permits the output current Iout to decrease more. This helps prevent a current overshoot. The set number of times to perform skipping operation can be set with the setting signal Sset transmitted by serial communication. For example, the set number of times can be set between one and seven. The set number of times can be set, instead of by serial communication, with a decoder or with a setting resistor.

### <4-2. Second Scheme>

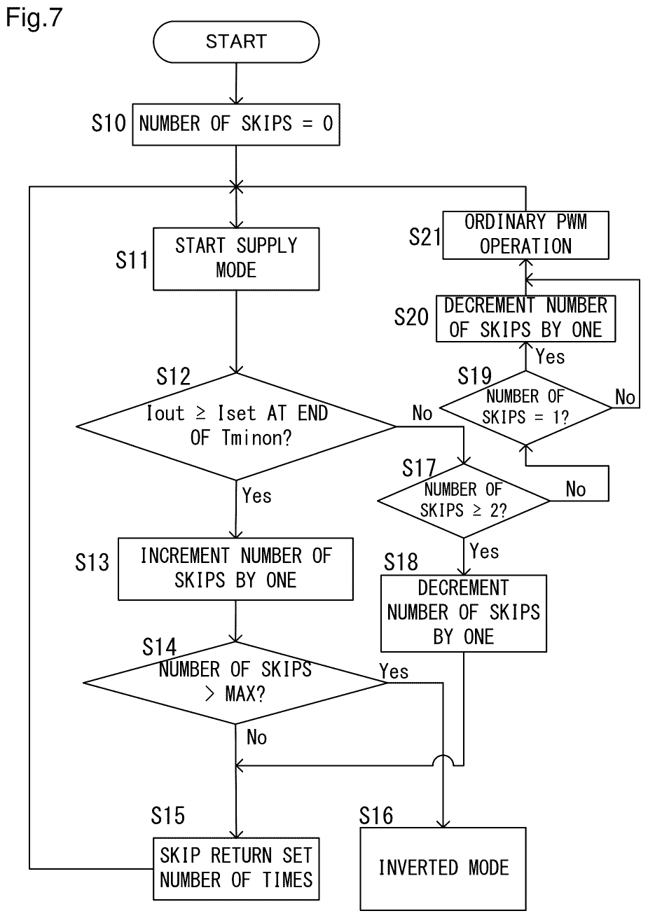

FIG. 7 is a flow chart of output current control according to a second scheme. In the control in FIG. 7, first, at Step S10, the number of skips is initialized to zero. Then, at Step S11, the supply mode is started and the output current Iout starts increasing.

Then, at the end of the first period T1, that is, the minimum on period Tminon, at Step S12, the control logic 2B checks whether the output current Iout has reached the set current value Iset.

If the output current Iout has reached the set current value Iset (Step S12, Yes), an advance is made to Step S13. At Step S13, the number of skips is incremented by one. Then, at Step S14, whether the number of skips has exceeded a predetermined maximum number MAX. If not (Step S14, No), an advance is made to Step S15, where a switch is made to the decay mode and skipping operation is performed to carry out the number of skips. After Step S15, a return is made to Step S11, where the supply mode is started.

By contrast, if at Step S12 the output current Iout has not reached the set current value Iset (Step S12, No), an advance is made to Step S17. If the number of skips is two or more (Step S17, Yes), an advance is made to Step S18, where the number of skips is decremented by one. Then an advance is made the Step S15, where a switch to the decay mode is made and skipping operation is performed to carry out the number of skips.

However, if at Step S17 the number of skips is one or less (Step S17, No), an advance is made the Step S19. At Step S19, if the number of skips is one (Step S19, Yes), an advance is made the Step S20, where the number of skips is decremented by one. Then an advance is made the Step S21, where ordinary PWM constant-current control is performed. By contrast, if at Step S19 the number of skips is zero (Step S19, No), the number of skips is kept zero. Then an advance is made to Step S21, where ordinary PWM constant-current control is performed. After Step S21, a return is made the Step S11, where the supply mode is started.

FIG. 8 is a diagram showing an example of waveforms observed in the output current control according to the second scheme. At timing t1 in FIG. 8, the supply mode is started and the output current Iout start increasing. At the end of the minimum on period Tminon (first period T1), that is, at timing t2, the output current Iout has reached the set current value Iset and thus at timing tskp1 a switch to the supply mode is skipped only once. As a result, in the period from timing t2 to timing tr1, the output current Iout decreases. Then, at timing tr1, the supply mode is started and the output current Iout start increasing. After that, at the end of the minimum on period Tminon (first period T1), that is, at timing t3, the output current Iout has reached the set current value Iset and thus a switch to the supply mode is skipped at timings tskp2 and tskp3; that is, skips are made only twice. As a result, in the period from timing t3 to timing tr2, the output current Iout decreases. Then, at timing tr2, the supply mode is started and the output current Iout starts increasing.

Through the output current control according to the second scheme as described above, if the output current Iout has reached the set current value Iset, until it no longer reaches it the number of skips is increased automatically to reduce the output current Iout. It is thus possible to prevent a current overshoot. When the output current Iout no longer reaches the set current value Iset, so long as it does not reach it the number of skips is reduced automatically to increase the output current Iout. Then a switch to ordinary PWM constant-current control can be made.

If at Step S14 the number of skips exceeds the maximum number MAX (e.g., around 100) (Step S14, Yes), an advance is made to Step S16, where a switch is made to an inverted mode. The inverted mode is a mode in which the H-bridge circuit 3B is controlled with the same switch states as when the output current Iout is supplied with the polarity opposite to its polarity at present. That is, in a case where the output current Iout has, for example, a positive polarity, in the H-bridge circuit 3B, the output transistors M1 and M4 kept are off and the output transistors M2 and M3 are kept on. Thus the output current Iout with a positive polarity decays fast. Here, a reverse current detector for detecting based on the current sense signal Vrnf a reverse flow of the output current Iout can be provided, in which case, on detection of a reverse flow of the decaying output current Iout, all the output transistors M1 to M4 are kept off. This makes it possible to keep the output current Iout off.

### <4-3. Third Scheme>

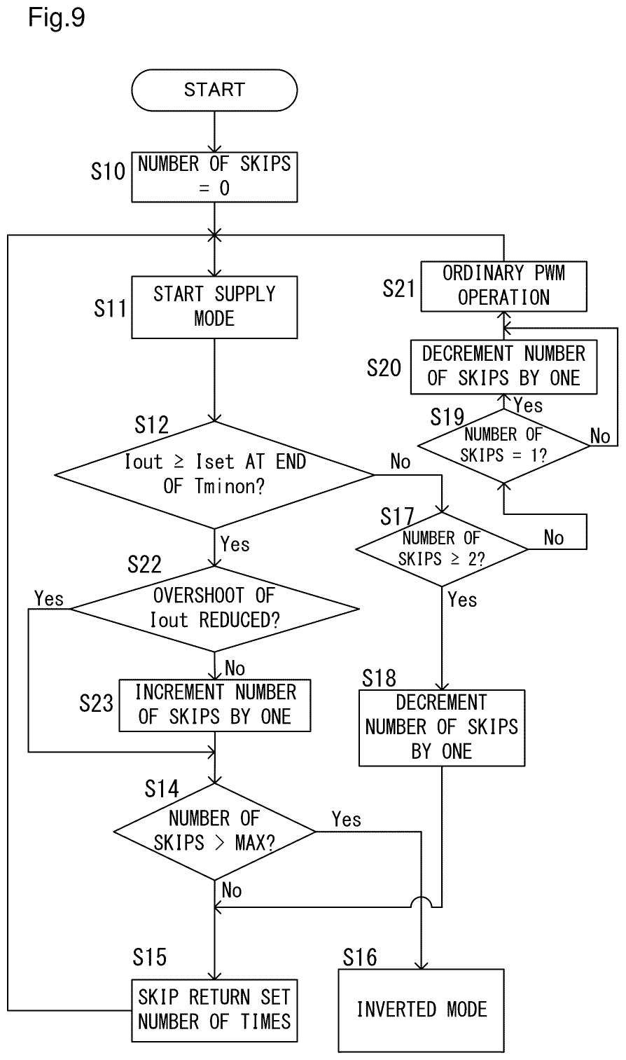

FIG. 9 is a flow chart of output current control according to a third scheme. The differences of the control in FIG. 9 from the control according to the second scheme (FIG. 7) described previously are steps S22 and S23 in FIG. 9. If at Step S12 the output current Iout has reached the set current value Iset (Step S12, Yes), an advance is made to Step S22, where whether the overshoot of the output current Iout above the set current value Iset has reduced from last time. If no reduction is observed (Step S22, No), an advance is made to Step S23, where the number of skips is incremented by one; if a reduction is observed (Step S22, Yes), no advance is made to Step S23. When Step S22 is reached for the first time after the output current Iout has reached the set current value Iset, an advance is made to Step S23.

With this scheme, if an overshoot of the output current Iout above the set current value Iset reduces, the number of skips is kept unchanged, and this helps prevent an unwanted drop in the output current Iout.

### <4-4. Fourth Scheme>

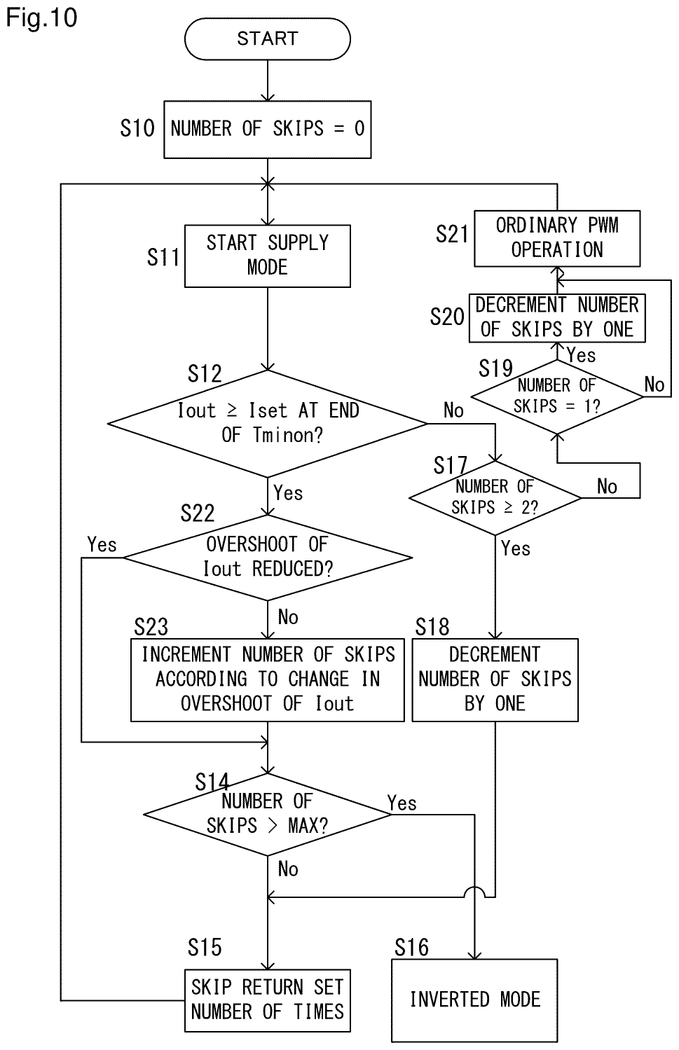

FIG. 10 is a flow chart of output current control according to a fourth scheme. The difference of the control in FIG. 10 from the control according to the third scheme (FIG. 9) described previously is the operation at Step S23. In this scheme, at Step S23, according to a change (increase) from last time of the overshoot of the output current Iout above the set current value Iset, the number of skips is increased. The larger the change is, the number by which the number of skips is incremented is increased. In this way it is possible to appropriately reduce an overshoot of the output current Iout above the set current value Iset.

### <4-5. Fifth Scheme>

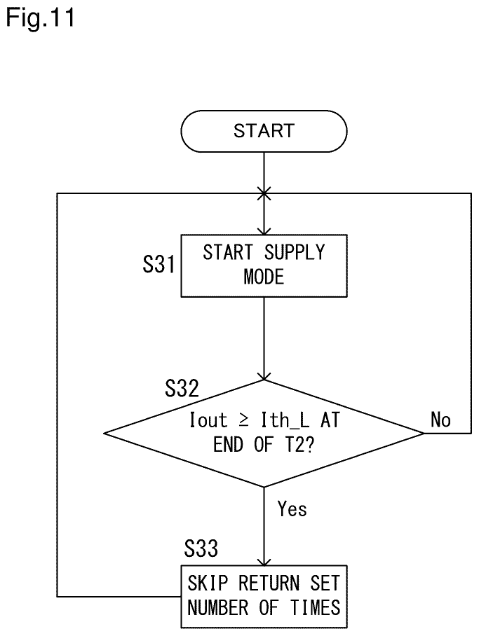

FIG. 11 is a flow chart of output current control according to a fifth scheme. In the control in FIG. 11, first, at Step S31, the supply mode is started. Here, ordinary PWM constant-current control is performed. FIG. 12 shows an example of waveforms observed in the output current control of this scheme and the description proceeds with reference also to FIG. 12. At the start of the first period T1 shown in FIG. 12, the supply mode is started and the output current Iout starts increasing. At the lapse of the first period T1, that is, the minimum on period Tminon, the output current Iout has exceeded the set current value Iset and thus, by PWM constant-current control, a switch to the decay mode is made immediately.

At the end of the second period T2, at Step S32, whether the output current Iout has reached a predetermined current threshold value Ith_L is checked. If Iout≥Ith_L and the output current Iout has not reached the current threshold value Ith_L (Step S32, Yes), an advance is made to Step S33, where skipping operation is performed the set number of times as previously set.

In the example in FIG. 12, at the end of the decay mode, that is, at timing tskp1, Iout≥Ith_L, and thus skipping operation is performed with two as the set number of times. After Step S33, a return is made to Step S31, where the supply mode is started. In the example in FIG. 12, at timing tr, the supply mode is started.

By contrast, if at Step S32 the output current Iout has reached the current threshold value Ith_L (Step S32, No), a return is made to Step S31, where the supply mode is performed.

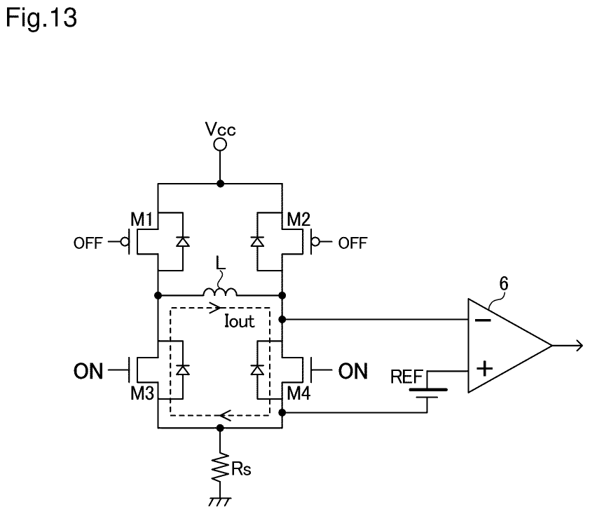

Here, in the slow decay mode (at right in FIG. 4A), the current sense signal Vrnf is at 0 V, and thus the output current Iout cannot be sensed based on the current sense signal Vrnf. To cope with this, as shown in FIG. 13, the drain voltage of the output transistor M4 (lower transistor) is fed to one input terminal of a comparator 6, and its other input terminal is fed with a reference voltage REF relative to the source of the output transistor M4. Thus, the comparator 6 can compare the output current Iout in the decay mode with the current threshold value Ith_L.

### 5. Application in Motor Driving

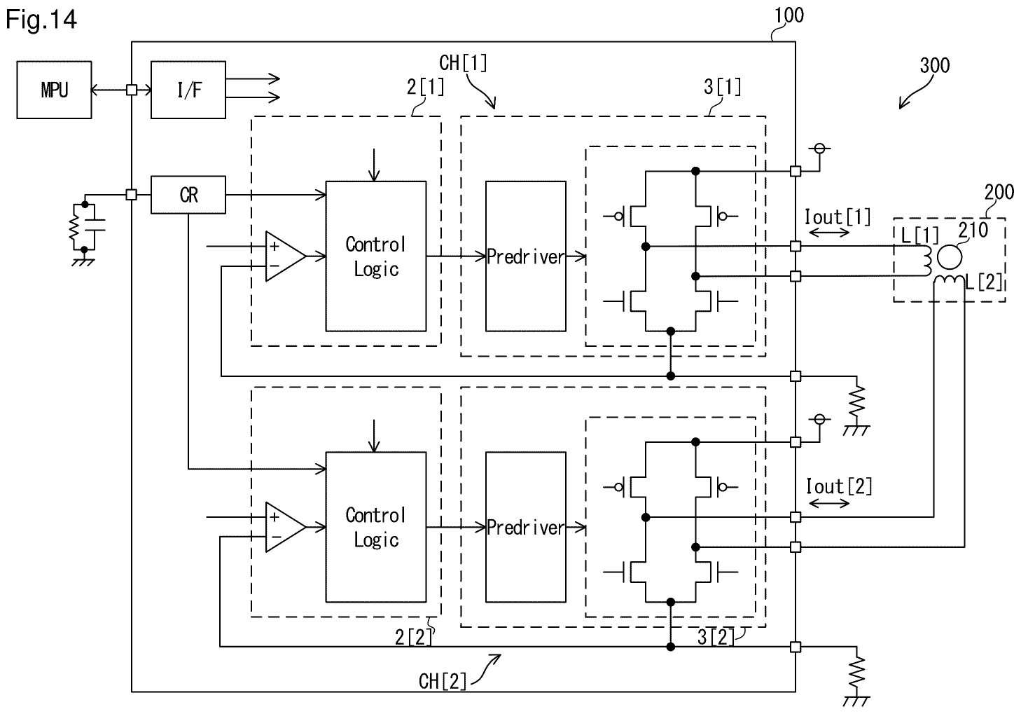

A driver device according to the present disclosure can be applied in motor driving. An example of application in motor driving will now be described. FIG. 14 shows the configuration of a motor driving device 300 that includes a driver device 100 according to the present disclosure.

The driver device 100 has two channels CH. In FIG. 14, the suffix “[i]” to a reference sign indicates an element corresponding the channel CH [i]. As shown in FIG. 14, the driver device 100 includes, for each channel, a configuration similar to the control circuit 2 and the output stage circuit 3 shown in FIG. 1.

The output stage circuit 3 of each channel CH includes an H-bridge circuit, which is connected to the coil L, corresponding to that channel CH, in a motor 200. The circuits of each channel in the driver device 100 control the output current of that channel. Thus the rotation of a rotor 210 included in the motor 200 is controlled.

Output current control for suppressing a current overshoot as described previously can be implemented in the circuits of each channel.

### 6. Modifications

While illustrative embodiments have been described, they can be modified in many ways without departure from the spirit of the present invention. The embodiments described above may be implemented in any combination.

### 7. Notes

As described above, according to one aspect of the present disclosure, a driver device (1) includes:
an H-bridge circuit (3B) that is connectable to a coil (L) and a resistor (R15) and that supplies an output current (Iout) to the coil by applying a voltage to it;
a control circuit (2) that controls the H-bridge circuit based on a current setting signal (Iset) for setting a set current value of the output current to be supplied to the coil and a current sense signal (Vrnf) indicating the result of sensing of the output current; and
a pulse generation circuit (5) that generates, within one period, a pulse waveform (Spl) with a first voltage level in a first period (T1) and a pulse waveform with a second voltage level in a second period (T2).

The control circuit makes the first period equal to a minimum on period (Tminon) to perform a supply mode for the minimum on period and, if at the end of the minimum on period the output current has reached the set current value, the control circuit makes a switch to a decay mode and performs a skip of a switch to the supply mode at the end of the second period. (A first configuration.)

In the first configuration described above, the number of skips to be made may be settable from outside the driver device. (A second configuration.)

In the first configuration described above, after the skip, the control circuit may resume the supply mode and, if the output current thereafter reaches the set current value, the control circuit may increment by one the number of skips to be made. (A third configuration.)

In the third configuration described above, after the skip, the control circuit may resume the supply mode and, if the output current thereafter does not reach the set current value, the control circuit may decrement by one the number of skips to be made. (A fourth configuration.)

In the first configuration described above, after the skip, the control circuit may resume the supply mode and, if the output current thereafter reaches the set current value, on detecting a decrease in an overshoot of the output current above the set current value as compared with last time, the control circuit may keep unchanged the number of skips to be made. (A fifth configuration.)

In the fifth configuration described above, after the skip, the control circuit may resumes the supply mode and, if the output current thereafter reaches the set current value, on detecting an increase in the overshoot of the output current above the set current value as compared with last time, the control circuit may increase the number of skips to be made by a number corresponding to the increase in the overshoot. (A sixth configuration.)

In any of the third to sixth configurations described above, if even when the number of skips to be made has reached a maximum number the output current reaches the set current value, the control circuit may control the H-bridge circuit in the supply mode with a polarity opposite to the polarity of the output current at present. (A seventh configuration.)

According to another aspect of the present disclosure, a driver device (1) includes:
an H-bridge circuit (3B) that is connectable to a coil (L) and a resistor (R15) and that supplies an output current (Iout) to the coil by applying a voltage to it;
a control circuit (2) that controls the H-bridge circuit based on a current setting signal (Iset) for setting a set current value of the output current to be supplied to the coil and a current sense signal (Vrnf) indicating the result of sensing of the output current; and
a pulse generation circuit (5) that generates, within one period, a pulse waveform (Spl) with a first voltage level in a first period (T1) and a pulse waveform with a second voltage level in a second period (T2).

The control circuit makes the first period equal to a minimum on period (Tminon) to perform a supply mode for the minimum on period and then makes a switch to a decay mode and, if at the end of the second period the output current has not reached a current threshold value (Ith_L), the control circuit performs a skip of a switch to the supply mode at the end of the second period. (An eighth configuration.)

The eighth configuration described above may further include a comparator (6) fed with the drain voltage of a lower transistor (M4) in the H-bridge circuit. Based on the output of the comparator, the control circuit may judge whether the output current has reached the current threshold value at the end of the second period. (A ninth configuration.)

According to yet another aspect of the present disclosure, a water treatment apparatus (10) for treating water of which the water quality resistance acts as the resistor (R15) includes: the driver (1) of any of the configurations described above; and the coil (L). (A tenth configuration.)

According to a further aspect of the present disclosure, a motor driving device (300) includes: the driver device (100) of any of the configurations described above; and a motor (200) including the coil (L[i]) and the resistor. (An eleventh configuration.)

### INDUSTRIAL APPLICABILITY

The present disclosure finds applications in a variety of systems that achieve driving using a coil.

### REFERENCE SIGNS LIST

1 driver device
2 control circuit
2A comparator
2B control logic
3 output stage circuit
3A pre-driver
3B H-bridge circuit
4 serial interface
5 CR timer
5A switch
5B resistor
5C comparator
6 comparator
10 hypochlorous acid water generating apparatus
15 water
100 driver device
200 motor
210 rotor
300 motor driving device
Aout, Bout output terminal
Ea, Eb electrode
L coil
M1-M4 output transistor
R15 water quality resistance
RNF resistor connection terminal
Rs current sense resistor
Tcr CR setting terminal
Tif interface terminal
VCC supply terminal

1. A driver device comprising:
an H-bridge circuit connectable to a coil and a resistor, the H-bridge circuit being configured to supply an output current to the coil by applying a voltage thereto;
a control circuit configured to control the H-bridge circuit based on
a current setting signal for setting a set current value of the output current to be supplied to the coil and
a current sense signal indicating a result of sensing of the output current; and
a pulse generation circuit configured to generate, within one period,
a pulse waveform with a first voltage level in a first period and
a pulse waveform with a second voltage level in a second period,
wherein
the control circuit makes the first period equal to a minimum on period to perform a supply mode for the minimum on period and, if at an end of the minimum on period the output current has reached the set current value, the control circuit makes a switch to a decay mode and performs a skip of a switch to the supply mode at an end of the second period.

2. The driver device according to claim 1, wherein
a number of skips to be made is settable from outside the driver device.

3. The driver device according to claim 1, wherein
after the skip, the control circuit resumes the supply mode and, if the output current thereafter reaches the set current value, the control circuit increments by one the number of skips to be made.

4. The driver device according to claim 3, wherein
after the skip, the control circuit resumes the supply mode and, if the output current thereafter does not reach the set current value, the control circuit decrements by one the number of skips to be made.

5. The driver device according to claim 1, wherein
after the skip, the control circuit resumes the supply mode and, if the output current thereafter reaches the set current value, on detecting a decrease in an overshoot of the output current above the set current value as compared with last time, the control circuit keeps unchanged the number of skips to be made.

6. The driver device according to claim 5, wherein
after the skip, the control circuit resumes the supply mode and, if the output current thereafter reaches the set current value, on detecting an increase in the overshoot of the output current above the set current value as compared with last time, the control circuit increases the number of skips to be made by a number corresponding to the increase in the overshoot.

7. The driver device according to claim 3, wherein
if even when the number of skips to be made has reached a maximum number the output current reaches the set current value, the control circuit controls the H-bridge circuit in the supply mode with a polarity opposite to a polarity of the output current at present.

8. A driver device comprising:
an H-bridge circuit connectable to a coil and a resistor, the H-bridge circuit being configured to supply an output current to the coil by applying a voltage thereto;
a control circuit configured to control the H-bridge circuit based on
a current setting signal for setting a set current value of the output current to be supplied to the coil and
a current sense signal indicating a result of sensing of the output current; and
a pulse generation circuit configured to generate, within one period,
a pulse waveform with a first voltage level in a first period and
a pulse waveform with a second voltage level in a second period,
wherein
the control circuit makes the first period equal to a minimum on period to perform a supply mode for the minimum on period and then makes a switch to a decay mode and, if at an end of the second period the output current has not reached a current threshold value, the control circuit performs a skip of a switch to the supply mode at the end of the second period.

9. The driver device according to claim 8, further comprising a comparator fed with a drain voltage of a lower transistor in the H-bridge circuit, wherein
based on an output of the comparator, the control circuit judges whether the output current has reached the current threshold value at the end of the second period.

10. A water treatment apparatus for treating water of which a water quality resistance acts as the resistor, the water treatment apparatus comprising:
the driver device according to claim 1; and
the coil.

11. A motor driving device comprising:
the driver device according to claim 1; and
a motor including the coil and the resistor.
